(19) United States
(12) Patent Application Publication
(10) Pub. No.: US 2015/0007190 A1
(43) Pub. Date: Jan. 1, 2015

(54) TECHNIQUES TO AGGREGATE COMPUTE, MEMORY AND INPUT/OUTPUT RESOURCES ACROSS DEVICES

(71) Applicants: Paul S. Diefenbaugh, Portland, OR (US); Nithyananda Siva Jeganathan, Portland, OR (US); Eugene Gorbatov, Hillsboro, OR (US); Neven M. Abou Gazala, Kirkland, WA (US); John S. Howard, Hillsboro, OR (US); Vincent A. Merrick, Aloha, OR (US)

(72) Inventors: Paul S. Diefenbaugh, Portland, OR (US); Nithyananda Siva Jeganathan, Portland, OR (US); Eugene Gorbatov, Hillsboro, OR (US); Neven M. Abou Gazala, Kirkland, WA (US); John S. Howard, Hillsboro, OR (US); Vincent A. Merrick, Aloha, OR (US)

(21) Appl. No.: 14/129,534

(22) PCT Filed: Jun. 28, 2013
(86) PCT No.: PCT/US13/48787

§ 371 Date: Dec. 26, 2013

(51) Int. Cl. G06F 9/50; G06F 3/0488; G06F 1/32

(52) U.S. Cl. CPC G06F 9/5011; G06F 1/3234; G06F 3/0488
USPC 718/104

(57) ABSTRACT

Examples are disclosed for aggregating compute, memory and input/output (I/O) resources across devices. In some examples, a first device may migrate to a second device at least some compute, memory or I/O resources associated with executing one or more applications. Migration of at least some compute, memory or I/O resources for executing the one or more applications may enable the first device to save power and/or utilize enhanced processing capabilities of the second device. In some examples, migration of compute, memory or I/O resources for executing the one or more applications may occur in a manner transparent to an operating system for the first device or the second device. Other examples are described and claimed.

### TECHNICAL FIELD

Examples described herein are generally related to aggregating resources across computing devices.

### BACKGROUND

Computing devices in various form factors are being developed that include increasing amounts of computing power, networking capabilities and memory/storage capacities. Some form factors attempt to be small and/or light enough to actually be worn by a user. For example, eyewear, wrist bands, necklaces or other types of wearable form factors are being considered as possible form factors for computing devices. Additionally, mobile form factors such as smart phones or tablets have greatly increased computing and networking capabilities and their use has grown exponentially over recent years.

### BRIEF DESCRIPTION OF THE DRAWINGS

FIG. 1 illustrates an example of a first system.

FIG. 2 illustrates an example of a second system.

FIG. 3 illustrates an example of a process.

FIG. 4 illustrates an example block diagram for a first apparatus.

FIG. 5 illustrates an example of a first logic flow.

FIG. 6 illustrates an example of a first storage medium.

FIG. 7 illustrates an example block diagram for a second apparatus.

FIG. 8 illustrates an example of a second logic flow.

FIG. 9 illustrates an example of a second storage medium.

FIG. 10 illustrates an example of a device.

### DETAILED DESCRIPTION

Examples are generally directed to improvements for aggregating compute, memory and input/output (I/O) resources across devices. Aggregation across devices such as computing devices may be influenced by possibly utilizing multiple computing devices that may each have different functionality and/or capabilities. For example, some computing devices may be small enough for a user to actually wear the computing device. Other types of small form factor computing devices may include smart phones or tablets where size/weight and a long battery life are desirable traits for users of these devices. Hence, wearable, smart phone or tablet computing devices may each be relatively light weight and may use low amounts of power to extend battery life.

Other types of computing devices may be somewhat stationary and may therefore have a larger form factor that is powered by a fixed power source or a comparatively larger battery compared to wearable, smart phone or tablet computing devices. These other computing devices may include desktop computers, laptops, or all-in-one computers having an integrated, large format (e.g., greater than 15 inches) display. The large form factor of these other devices and the use of a fixed power source (e.g., via a power outlet) or a large battery power source may allow for considerably more computing, memory or I/O resources to be included with or attached to these form factors. In particular, a higher thermal capacity associated with a larger form factor along with possible use of active cooling (e.g., via one or more fans) may allow for the considerably more computing, memory or I/O resources as compared to smaller form factors.

In contrast, wearable, smart phone or tablet computing devices, as mentioned are in relatively small form factors that depend on battery power and likely do not have active cooling capabilities. Also, power circuitry and use of a battery may reduce current-carrying capacity of these types of devices. A reduced current-carrying capacity may restrict types of potentially powerful computing resources from being implemented in these smaller form factors.

Aggregation of compute, memory and input/output (I/O) resources across computing devices having different capabilities may be a desirable objective. Current attempts to aggregate these resources across computing devices have relied primarily on software implementations. These types of software implementations usually result in high latencies and degraded user experience. For example, user-perceptible delays associated with software implementations may result when streaming high-definition video or gaming information between aggregating devices such as a smart phone and an all-in-one computer. The user-perceptible delays may result in a choppy video and frustratingly slow responses to user inputs. Thus a seamless aggregation of computing resources across multiple computing devices may be problematic when relying primarily on software implementations for the aggregation. It is with respect to these and other challenges that the examples described herein are needed.

According to some examples, example first methods may be implemented at a first device having a first circuitry, e.g., processing element(s) and/or graphic engine(s). One or more applications may be executed on the first circuitry. A second device having second circuitry capable of executing the one or more applications may be detected. Logic and/or features at the first device may cause the first device to connect to the second device and may then flush context information from a first near memory for the first circuitry. For these examples, the flushed context information may be for executing the one or more applications. The logic and/or features at the first device may then send the flushed context information to a second near memory for the second circuitry. The second circuitry may then use the context information in its near memory to execute the one or more applications. Also, for this example first methods, logic and/or features at the first device may route I/O information. The I/O information may be associated with the second circuitry executing the one or more applications. The logic and/or features at the first device may route the I/O information in a manner that is transparent to a first operating system (OS) for the first device or the second device.

In some other examples, example second methods may be implemented at a first device having a first circuitry. For these example second methods, an indication that a second device having second circuitry has connected to the first device may be detected. Context information flushed from a first near memory for the second circuitry may then be received by logic and/or features at the first device. The received flushed context information may enable the first circuitry at the first device to execute one or more applications previously executed by the second circuitry prior to the second device flushing the context information. The logic and/or features at the first device may cause the received context information to be at least temporarily stored to a second near memory for the first circuitry. Also, for these example second methods, I/O information associated with the first circuitry executing the one or more applications may also be received. The I/O information may be received by the logic and/or features at the first device in a manner that is transparent to a first OS for the first device or the second device.

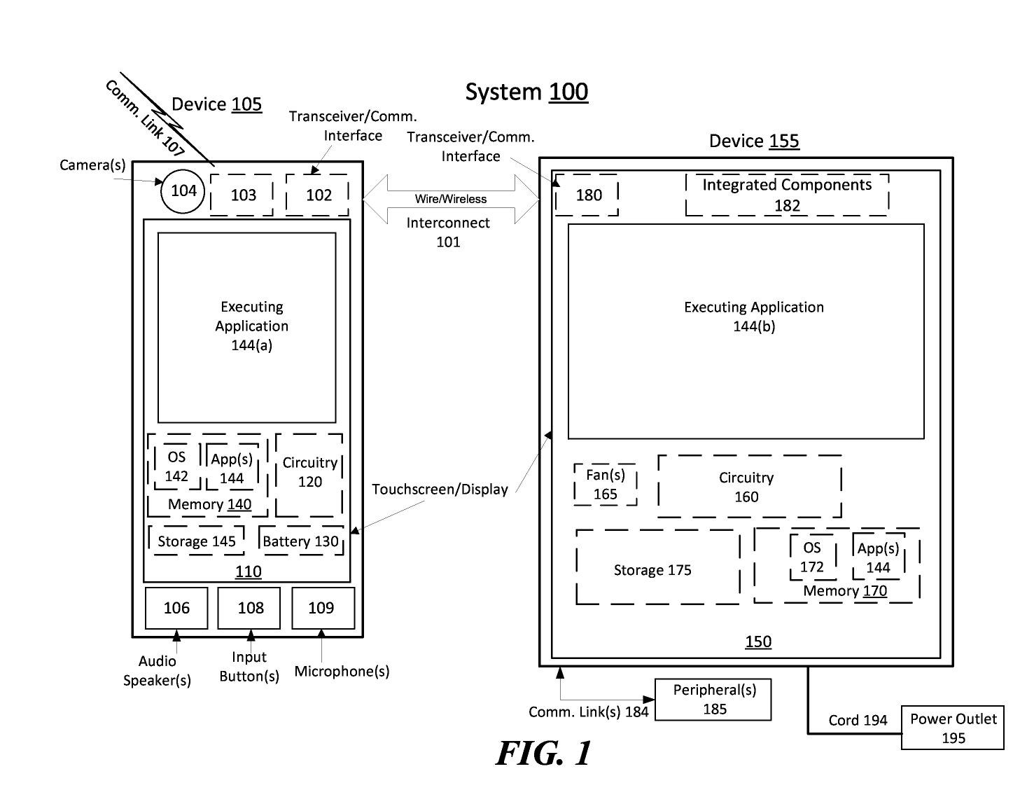

FIG. 1 illustrates an example first system. In some examples, the example first system includes system 100. System 100, as shown in FIG. 1, includes a device 105 and a device 155. According to some examples, devices 105 and 155 may represent two examples of different form factors for computing devices. As described more below, device 105 may be a smaller form factor that may operate primarily off battery power while device 155 may be a relatively larger form factor that may operate primarily off a fixed power source such as an alternating current (A/C) received via a power outlet associated, for example, with power purchased from a power utility.

In some examples, device 105 is shown in FIG. 1 as observed from a front side that may correspond to a side of device 105 that includes a touchscreen/display 110 that may present a view of executing application(s) 144(a) to a user of device 105. Similarly, device 155 is shown in FIG. 1 as observed from a front side that includes a touchscreen/display 150 that may present a view of executing application 144(b) to a user of device 155. Although, in some examples, a display may also exist on back side of device 105 or device 155, for ease of explanation, FIG. 1 does not include a back side display for either device.

According to some examples, the front side views of devices 105 and 155 include elements/features that may be at least partially visible to a user when viewing these devices from a front view. Also, some elements/features may not be visible to the user when viewing devices 105 or 155 from a front side view. For these examples, solid-lined boxes may represent those features that may be at least partially visible and dashed-line boxes may represent those element/features that may not be visible to the user (e.g., underneath a skin or cover). For example, transceiver/communication (comm.) interfaces 102 and 180 may not be visible to the user, yet at least a portion of camera(s) 104, audio speaker(s) 106, input button(s) 108, microphone(s) 109 or touchscreen/display 110 may be visible to the user.

According to some examples, as shown in FIG. 1, a comm. link 107 may wirelessly couple device 100 via network interface 103. For these examples, network interface 103 may be configured and/or capable of operating in compliance with one or more wireless communication standards to establish a network connection with a network (not shown) via comm. link 107. The network connection may enable device 105 to receive/transmit data and/or enable voice communications through the network.

In some examples, various elements/features of device 105 may be capable of providing sensor information associated with detected input commands (e.g., user gestures or audio command). For example, touch screen/display 110 may detect touch gestures. Camera(s) 104 may detect spatial/air gestures or pattern/object recognition. Microphone(s) 109 may detect audio commands. In some examples, a detected input command may be to affect executing application 144(a) and may be interpreted as a natural UI input event. Although not shown in FIG. 1 a physical keyboard or keypad may also receive input command that may affect executing application(s) 144(a).

According to some examples, as shown in FIG. 1, device 105 may include circuitry 120, a battery 130, a memory 140 and a storage 145. Circuitry 120 may include one or more processing elements and graphic engines capable of executing App(s) 144 at least temporarily maintained in memory 140. Also, circuitry 120 may be capable of executing operating system (OS) 142 which may also be at least temporarily maintained in memory 140.

In some examples, as shown in FIG. 1, device 155 may include circuitry 160, storage 175, memory 170 and transceiver/comm. interface 180. Device 155 may also include fan(s) 165 which may provide active cooling to components of device 155. Also, as shown in FIG. 1, device 155 may include integrated components 182. Integrated components 182 may include various I/O devices such as, but not limited to, cameras, microphones, speakers or sensors that may be integrated with device 155.

According to some examples, as shown in FIG. 1, device 155 may be coupled to a power outlet 195 via a cord 194. For these examples, device 155 may receive a fixed source of power (e.g., A/C power) via the coupling to power outlet 195 via cord 194.

In some examples, as shown in FIG. 1, device 155 may couple to peripheral(s) 185 via comm. link 184. For these examples, peripheral(s) 185 may include, but are not limited to, monitors, displays, external storage devices, speakers, microphones, game controllers, cameras, I/O input devices such as a keyboard, a mouse, a trackball or stylus.

According to some examples, logic and/or features of device 105 may be capable of detecting device 155. For example, transceiver/comm. interfaces 102 and 180 may each include wired and/or wireless interfaces that may enable device 105 to establish a wired/wireless communication channel to connect with device 155 via interconnect 101. In some examples, device 105 may physically connect to a wired interface (e.g., in docking station or a dongle) coupled to device 155. In other examples, device 105 may come within a given physical proximity that may enable device 105 to establish a wireless connection such as a wireless docking with device 155. Responsive to the wired or wireless connection, information may be exchanged that may enable device 105 to detect device 155 and also to determine at least some capabilities of device 155 such as circuitry available for executing App(s) 144.

In some examples wired and/or wireless interfaces included in transceiver/comm. interfaces 102 and 180 may operate in compliance with one or more low latency, high bandwidth and efficient interconnect technologies. Wired interconnect technologies may include, but are not limited to, those associated with industry standards or specifications (including progenies or variants) to include the Peripheral Component Interconnect (PCI) Express Base Specification, revision 3.0, published in November 2010 (“PCI Express” or “PCIe”) or interconnects similar Intel® QuickPath Interconnect (“QPI”). Wireless interconnect technologies may include, but are not limited to, those associated with WiGig™ and/or Wi-Fi™ and may include establishing and/or maintaining wireless communication channels through various frequency bands to include Wi-Fi and/or WiGig frequency bands, e.g., 2.4, 5 or 60 GHz. These types of wireless interconnect technologies may be described in various standards promulgated by the Institute of Electrical and Electronic Engineers (IEEE). These standards may include Ethernet wireless standards (including progenies and variants) associated with the IEEE Standard for Information technology—Telecommunications and information exchange between systems—Local and metropolitan area networks—Specific requirements Part 11: WLAN Media Access Controller (MAC) and Physical Layer (PHY) Specifications, published March 2012, and/or later versions of this standard (“IEEE 802.11”). One such standard related to WiFi and WiGig and also to wireless docking is IEEE 802.11ad.

According to some examples, circuitry 160 may include one or more processing elements and graphics engines capable of executing OS 172. Circuitry 160 may also be capable of executing at least a portion of App(s) 144. In some examples, context information associated with executing applications such as App(s) 144 may be sent from logic and/or features of device 105 via interconnect 101. The context information may enable circuitry 160 to execute at least a portion of App(s) 144. As described in more detail for other examples below, the context information may be flushed from a first near memory used by circuitry 120 (e.g., included in memory 140) and then sent to a second near memory at device 155 (e.g., included in memory 170). The second near memory now having the flushed context information may enable circuitry 160 to execute the at least portion of App(s) 144 which may result in a presentation of that execution on display 150 as executing application 144(b).

In some examples, App(s) 144 may include types of applications that a user of device 105 may desire to utilize increased computing, memory or I/O resources available at device 155. For example, due to active cooling, a fixed power source and a larger form factor, circuitry 160 may include a significantly higher amount of computing power than circuitry 120. This may be due, at least in part, to a higher thermal capacity for dissipating heat from circuitry 160 via use of fan(s) 165 and also to greater surface areas to dissipate heat via passive means such as large heat sinks or heat pipes. Thus, circuitry 160 can operate within a significantly higher thermal range. Further, receiving power via power outlet 195 may allow device 155 to provide a significantly higher current-carry capacity to circuitry 160. A higher current-carrying capacity may enable circuitry 160 to more quickly respond to rapid bursts of computing demand that may be common with some types of applications such as interactive gaming or video editing.

App(s) 144 may also include types of applications such as high definition streaming video applications (e.g., having at least 4K resolution) to be presented on larger displays such as displays having a vertical display distance of 15 inches or more. For example, circuitry 120 may be adequate for presenting high definition video on a relatively small touchscreen/display 110 but a larger touchscreen/display 150 may exceed the capability of circuitry 120 and/or the thermal capacity of device 105. Thus, circuitry 160 may be utilized to execute these types of applications to present the high definition streaming to the larger touchscreen/display 150 or to an even larger display possibly included in peripheral(s) 185.

App(s) 144 may also include a touch screen application capable of being used on large or small displays. For example, the touch screen application may be executed by circuitry 160 to present larger sized and/or higher resolution touch screen images to touchscreen/display 150. Also, the touch screen application may be able to mirror touch screen images on multiple screens. For example, a portion of the touch screen application may be implemented by circuitry 120 to present executing application 144(a) to touchscreen/display 110 and another portion may be implemented by circuitry 160 to present executing application 144(b) to touchscreen/display 150. For this example, coherency information may be exchanged between circuitry 120 and circuitry 160 via interconnect 101 to enable the joint execution of the touch screen application.

According to some examples, logic and/or features at device 105 may be capable of routing I/O information associated with circuitry 160 executing App(s) 144. For these examples, the I/O information may be routed in a manner that is transparent to at least OS 142 of device 105. As described more below, use of a two-level memory (2LM) system may allow for this type of information exchange that is transparent to an operating system such as OS 142.

An example of I/O information that may be routed is I/O information indicating an input command for App(s) 144 being executed by circuitry 160 that may have been detected by one or more components of device 105 such as a physical keyboard. The input command may also be detected via a natural UI input event such as a touch gesture, an air gesture, a device gesture, an audio command, an image recognition or a pattern recognition. The natural UI input event may be detected by one or more of camera(s) 104, microphone(s) 109, input button(s) or touchscreen/display 110

Another example of I/O information that may be routed includes a high definition video stream (e.g., at least 4K resolution) received through a network connection maintained by device 105 via comm. link 107. For this example, logic and/or features at device 105 may route the high definition video stream via interconnect 101 for circuitry 160, when executing a video display application, to cause the high definition video stream to be presented on a display coupled to device 155. The display coupled to device 155 may include touchscreen/display 150 or larger sized display that may have a vertical display distance of 15 inches or greater.

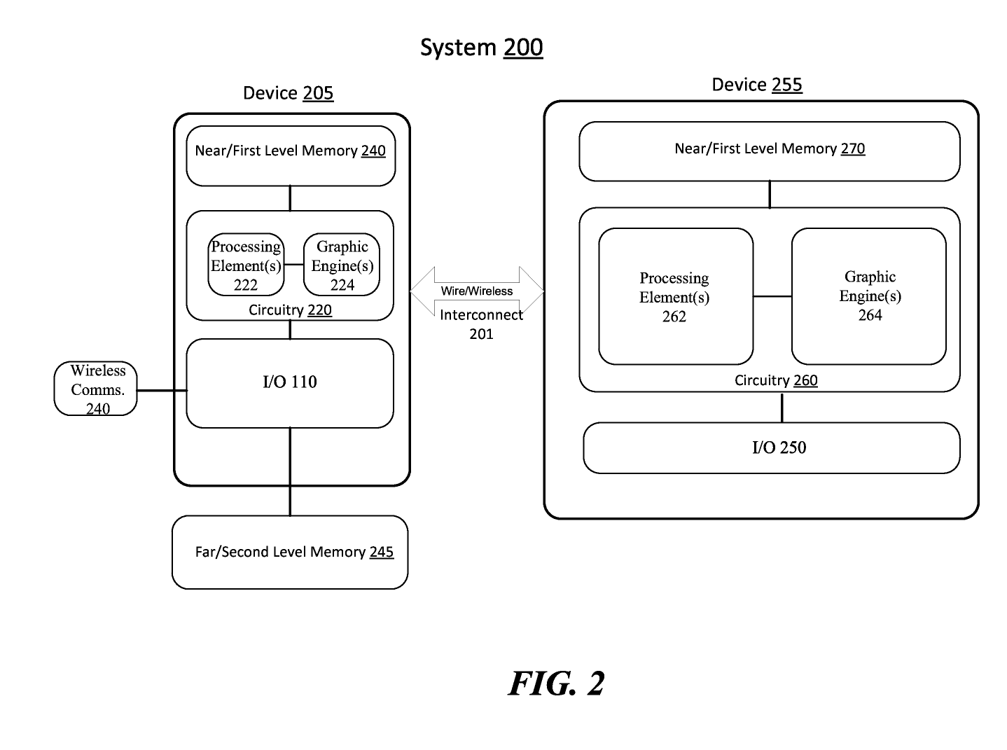

FIG. 2 illustrates an example second system. In some examples, the example second system includes system 200. System 200 as shown in FIG. 2 includes various components of a device 205 and a device 255. According to some examples, components of device 205 may be coupled to components of device 255 via an interconnect 201. Similar to device 105 and 155 mentioned above for FIG. 1, interconnect 201 may be established via wired or wireless communication channels through wired and/or wireless interfaces operating in compliance with various interconnect technologies and/or standards. As a result, interconnect 201 may represent a low latency, high bandwidth and efficient interconnect to allow for computing, memory or I/O resources to be aggregated between at least some components of devices 205 and 255.

In some examples, as shown in FIG. 2, device 205 may have circuitry 220 that includes processing element(s) 222 and graphic engine(s) 224. These elements of circuitry 220 may be capable of executing one or more applications similar to App(s) 144 mentioned above for FIG. 1. Also, device 255 may have circuitry 260 that includes processing element(s) 262 and graphic engine(s) 264. The relative sizes of the elements of circuitry 220 as depicted in FIG. 2 compared to circuitry 260 may represent increased computational abilities for device 255 compared to device 205. These increased computation abilities may be attributed, at least in part, to the various examples given above for device 155 when compared to device 105 (e.g., fixed power source, higher thermal capacity, high current-carrying capacity, larger form factor, etc.).

According to some examples, in addition to a low latency, high bandwidth and efficient interconnect, a 2LM scheme may be implemented at device 205 and device 255 to facilitate a quick and efficient exchange of context information for an application being executed by circuitry 220 to be switched and then executed by circuitry 260 in a somewhat seamless manner (e.g., occurs in a fraction of a second). For example, near/first level memory 240 at device 205 may low latency/higher performance types of memory such as Double-Data-Rate (DDR) random-access memory (RAM). Also near/first level memory 270 at device 255 may include similar types of memory. As part of the 2LM scheme, far/second level memory 245 may include higher latency/lower performance types of memory such as, but not limited to, one or more of 3-D cross-point memory, NAND flash memory, NOR flash memory, ferroelectric memory, silicon-oxide-nitride-oxide-silicon (SONOS) memory, polymer memory such as ferroelectric polymer memory, ferroelectric transistor random access memory (FeTRAM) or FeRAM) or ovonic memory.

In some examples, far/second level memory 245 may include a hybrid or multi-mode type of solid state drive (SSD) that may enable a relatively small portion of memory arrays/devices to fulfill the role as a type of system memory as observed by an OS for device 205 or 255. A relatively much larger portion of memory arrays/devices may then serve as storage for device 205.

In some examples, following establishment of interconnect 201, logic and/or features of device 205 may determine that an application being executed by circuitry 220 can be executed by circuitry 260 at device 255. For these examples, the logic and/or features of device 205 may flush context information for executing the application from near/first level memory 240. The flushed context information may then be sent, via interconnect 201, to near/first level memory 270 that may be accessible to circuitry 260 for execution of the application. Since types of memory included in near/first level memory 240 and near/first level memory 270 have low latencies as does interconnect 201, the flushing, sending and receiving of the context information may occur rapidly such that a user of device 205 may perceive the switch as nearly instantaneous.

According to some examples, logic and/or features at device 205 may then route I/O information associated with circuitry 260 now executing the application. For these examples, the at least portion of far/second level memory 245 serving as system memory for device 205 may facilitate this routing of I/O information such that an OS for device 205 and/or device 255 may not be aware of which near/first level memory is being used. As a result, the routing of the I/O information between device 205 and device 255 may be done in manner that is transparent to the OS for device 205 and/or an OS for device 255.

In some examples, the hybrid or multi-mode functionality of near/first level memory 240 may enable device 205 to use substantially less power by not having to maintain operating power levels for volatile types of system memory such as DDR RAM once context information is flushed. Additionally, the at least portion of far/second level memory 245 observed by the OS as system memory may mask or make transparent exchanges of information between devices 205 and 255. As such, the OS may not notice that the application has migrated for execution on circuitry existing on a separate device. Further, additional power may be saved by logic and/or features of device 205 powering down circuitry 220 to a sleep or similar type of power state following the flushing of context information from near/first level memory 240. Other components of device 205 may remain powered such a wireless comms. 240, I/O 210 and far/second level memory 245. But these other components may use a considerably less amount of power and thus device 205 may conserve a significant amount of battery power.

Although not shown in FIG. 2, in some examples, a far/second memory may also be maintained at device 255. For these examples, the far/second memory at device 255 may server as a type of cache to compensate for potential latency issues associated with interconnect 201. Also, the far/second memory at device 255 may allow logic and/or features of device 255 to use both near/first level memory 270 and the far/second memory at device 255 to support varying memory aperture sizes to be configured during connection with device 205. Thus, near/first level memory 270 may be dynamically sized to match a capacity to receive flushed context information from near/first level memory 240.

In some examples a forced memory migration may occur between the entire contents of near/first level memory 240 to near/first level memory 270. For these examples, rather than just flushing context information all information is flushed from near/first level memory 240 and then migrated to near/first level memory 270 in a similar manner as described above for context information.

According to some examples, as shown in FIG. 2, wireless comms. 240 may couple to device 205. For these examples, wireless comms. 240 may be means via which device 205 may serve as a tether for device 255 to either a wireless network or another device. This may occur through various type of wireless communication channels such as a Bluetooth™, WiFi, WiGig or a broadband wireless/4G wireless communication channel. I/O information associated with execution of the application may be received via these types of wireless communication channels. For example, high definition video may be streamed through a 4G wireless communication channel associated with a subscription or user account to access a 4G wireless network using device 205 but not device 255. For these examples, I/O 210 may be capable of receiving the streaming video information through wireless comms. 240 and at least temporarily store the streaming video at far/second level memory 245. Logic and/or features at device 205 may then route this I/O information via interconnect 201 to near/first level memory 270 for execution of a video display application by circuitry 260. Logic and/or features at device 205 may then cause the high definition video to be presented to a display (not shown) coupled to device 255 through I/O 250.

In some examples, logic and/or features of device 205 may receive an indication that the connection to device 255 via interconnect 201 is to be terminated. For example, a user of device 255 and/or 205 may indicate via an input command (e.g., detected via keyboard or natural UI input event) that device 205 is about to be physically disconnected from a wired communication channel. Alternatively, if interconnect 201 is through a wireless communication channel, logic and/or features of device 205 may detect movement of device 205 in a manner that may result in device 205 moving outside of a given physical proximity to device 255. The given proximity may be a range which device 205 may maintain an adequate wireless communication channel to exchange information via interconnect 201.

According to some examples, responsive to receiving the indication of a pending termination of interconnect 201, logic and/or features of device 205 may cause circuitry 220 and near/first level memory 240 to power back up to an operational power state. As mentioned above, these components of device 205 may have been powered down following the flushing of context information. For these examples, logic and/or features of device 255 may cause context information for executing an application at circuitry 260 to be flushed from near/first level memory 270 and sent to near/first level memory 240 via interconnect 201. Once the context information is received to near/first level memory 240, circuitry 220 may then resume execution of the application. In some examples, logic and/or features at device 255 may then power down circuitry 260 or near/first level memory 270 once the context information is flushed and sent to device 205 via interconnect 201.

In some examples, various schemes may be implemented by logic and/or features of device 255 to facilitate a rapid flushing of context information from near/first level memory 270 following an indication of a pending termination of interconnect 201. The various schemes may be needed due to a potentially large difference in memory capacities between near/first level memory 270 and near/first level memory 240. This large difference may be due to similar reasons for the difference in computational resources (e.g., fixed power, higher thermal capacity, larger form factor, etc.). The various schemes may include restricting an amount of context information maintained in near/first level memory 270 during execution of an application such that context information can be flushed and sent to near/first level memory 240 without overwhelming the capacity of near/first level memory 240 and/or interconnect 201 to handle that context information in an efficient and timely manner.

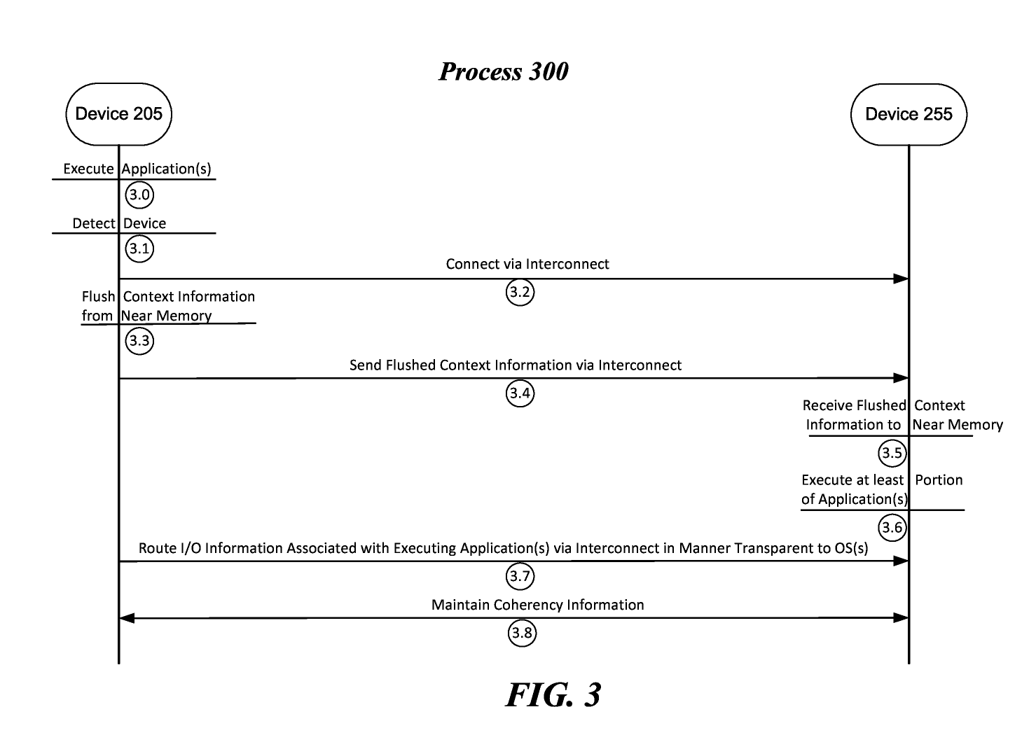

FIG. 3 illustrates an example process 300. In some examples, process 300 may be for a first device having first circuitry to migrate at least a portion of execution of an application to a second device having second circuitry. For these examples, elements of system 200 as shown in FIG. 2 may be used to illustrate example operations related to process 300. However, the example operations are not limited to implementations using elements of system 200.

Beginning at process 3.0 (Execute Application(s)), circuitry 220 of device 205 may be executing one or more applications. For example, the one or more applications may include a video streaming application to present streaming video to a display at device 205.

Proceeding to process 3.1 (Detect Device), logic and/or features at device 205 may detect device 255 having circuitry 260 capable of executing at least a portion of the one or more applications being executed by device 255.

Proceeding to process 3.2 (Connect via Interconnect), logic and/or features at device 205 may cause device 205 to connect to device 255 via interconnect 201. In some examples, the connection for interconnect 201 may be via a wired communication channel. In other examples, the connection for interconnect 201 may be via a wireless communication channel.

Proceeding to process 3.3 (Flush Context Information from Near Memory), logic and/or features at device 205 may cause context information used to execute the at least portion of the one or more applications to be flushed from near/first level memory 240. For example, video frame information at least temporarily maintained in near/first level memory 240 may be flushed. For these examples, the logic and/or features at device 205, following the flush of context information may cause quiescent execution of the at least portion of application(s) by circuitry 220.

Proceeding to process 3.4 (Send Flushed Context Information via Interconnect), logic and/or feature at device 205 may cause the flushed context information to be sent to device 255 via interconnect 201. In some examples, the flushed context information may be first sent to far/second memory 245 prior to being sent to device 255 via interconnect 201.

Proceeding to process 3.5 (Receive Flushed Context Information to Near Memory), logic and/or features at device 255 may receive the flushed context information to near/first level memory 270.

Proceeding to process 3.6 (Execute at least Portion of Application(s)), circuitry 260 may execute the at least portion of applications using the flushed context information received to near/first level memory 270. For example, video frame information for executing the video display application may be used to present streaming video to a display coupled to device 255. The streaming video may be high definition video (e.g., at least 4K resolution) presented to a large size display (e.g., greater than 15 inches).

Proceeding to process 3.7 (Route I/O Information Associated with Executing Application(s) via Interconnect in Manner Transparent to OS(s)), logic and/or features at device 205 may route I/O information via interconnect 201 in a manner transparent to an OS for device 205 and/or device 255. For example, the I/O information may include user input commands associated with the user viewing displayed video. The user input commands may be detected by logic and/or features at device 205 (e.g., a user gesture) and may indicate pausing a video. The I/O information to pause the video may be routed to device 255 via interconnect 201 and the video display application being executed by circuitry 260 may cause the video to be paused.

Proceeding to process 3.8 (Maintain Coherency Information), logic and/or features at both device 205 and device 255 may maintain coherency information between circuitry 220 and circuitry 260. In some examples, rather than powering down circuitry 220 following the flushing of context information, circuitry 220 may continue to execute at least a portion of the one or more applications. This may enable execution of the one or more applications in a distributed or shared manner. For these examples, circuitry 270 may execute at least the portion of the one or more applications while circuitry 240 executes a remaining portion of the one or more applications.

In some examples, process 300 may continue until a disconnection/termination of interconnect 201. As mentioned above, logic and/or features at device 205 and 255 may implement various actions to allow the at least portion of the one or more applications to migrate back to circuitry 220 prior to the termination of interconnect 201.

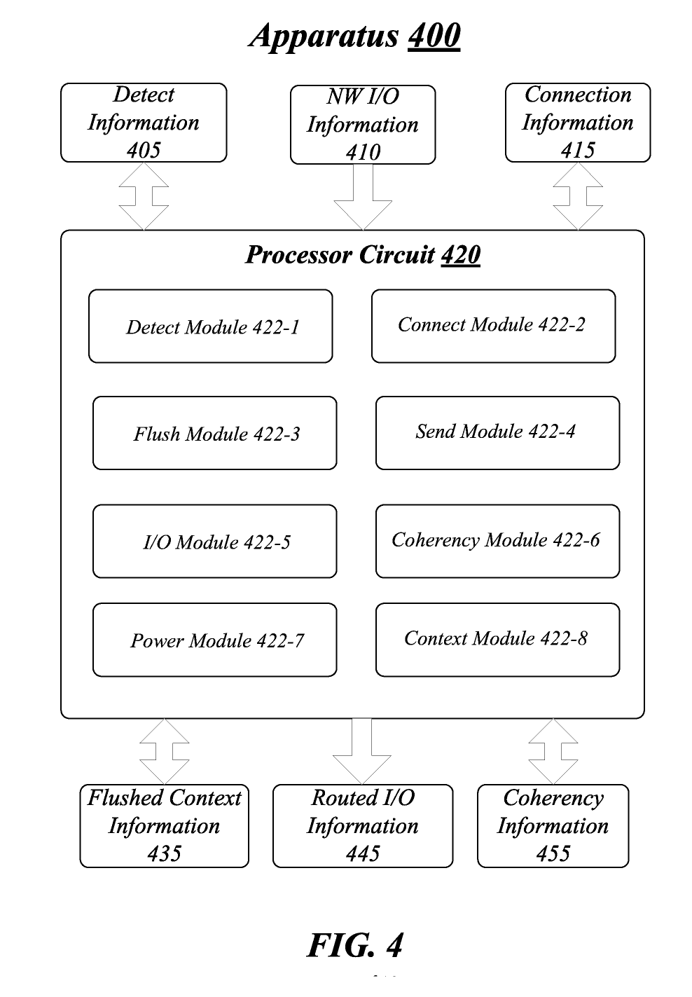

FIG. 4 illustrates a block diagram for a first apparatus. As shown in FIG. 4, the first apparatus includes an apparatus 400. Although apparatus 400 shown in FIG. 4 has a limited number of elements in a certain topology or configuration, it may be appreciated that apparatus 400 may include more or less elements in alternate configurations as desired for a given implementation.

The apparatus 400 may include a computing device and/or firmware implemented apparatus 400 having processor circuit 420 arranged to execute one or more logics 422-a. It is worthy to note that “a” and “b” and “c” and similar designators as used herein are intended to be variables representing any positive integer. Thus, for example, if an implementation sets a value for a=8, then a complete set of logics 422-a may include logics 422-1, 422-2, 422-3, 422-4, 422-5, 422-6, 422-7 or 422-8. The examples are not limited in this context.

According to some examples, apparatus 400 may be part a first device having first circuitry for executing an application (e.g. device 105 or 205). The examples are not limited in this context.

In some examples, as shown in FIG. 4, apparatus 400 includes processor circuit 420. Processor circuit 420 may be generally arranged to execute one or more logics 422-a. Processor circuit 420 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Qualcomm® Snapdragon®; Intel® Celeron®, Core (2) Duo®, Core i3, Core i5, Core i7, Itanium®, Pentium®, Xeon®, Atom® and XScale® processors; and similar processors. Dual microprocessors, multi-core processors, and other multi-processor architectures may also be employed as processor circuit 420. According to some examples processor circuit 420 may also be an application specific integrated circuit (ASIC) and logics 422-a may be implemented as hardware elements of the ASIC.

According to some examples, apparatus 400 may include a detect logic 422-1. Detect logic 422-1 may be executed by processor circuit 420 to detect a second device having second circuitry capable of executing at least a portion of an application. For example, detect logic 422-1 may receive detect information 405 that may indicate that the second device has connected to the first device via either a wired or wireless communication channel.

In some examples, apparatus 400 may also include a connect logic 422-2. Connect logic 422-2 may be executed by processor circuit 420 to cause the first device to connect to the second device via an interconnect. For example, connect logic 422-2 may connect to the second device via an interconnect that may operate in compliance with one or more low latency, high bandwidth and efficient interconnect technologies such as PCIe, QPI, WiGig or Wi-Fi.

According to some examples, apparatus 400 may also include a flush logic 422-3. Flush logic 422-3 may be executed by processor circuit 420 to flush context information from a near memory for the first circuitry. This flushed context information may be for at least the portion of the application.

According to some examples, apparatus 400 may include a send logic 422-4. Send logic 422-4 may be executed by processor circuit 420 to send, via the interconnect, the flushed context information to a second near memory for the second circuitry to execute at least the portion of the application. For example, the flushed context information may be included in flushed context information 435.

In some examples, apparatus 400 may also include an I/O logic 422-5. I/O logic 422-5 may be executed by processor circuit 420 to route, via the interconnect, I/O information associated with the second circuitry executing at least the portion of the application. The I/O information may be routed in a manner that is transparent to a first OS for the first device or the second device. For example, the I/O information may be received via NW I/O information 410 and then included in routed I/O information 445. Routed I/O information may include such information as detected user input commands for affecting the execution of the at least portion of the application.

According to some examples, apparatus 400 may also include a coherency logic 422-6. Coherency logic 422-6 may be executed by processor circuit 420 to maintain coherency information between the first circuitry and the second circuitry via the interconnect to enable execution of the application in a distributed or shared manner. For these examples, the second circuitry may execute at least the portion of the application while the first circuitry executes a remaining portion of the application. For example, coherency information included in coherency information 455 may be exchanged between the first and second device to allow coherency logic 422-6 to maintain the coherency information.

According to some examples, apparatus 400 may include a power logic 422-7. Power logic 422-7 may be executed by processor circuit 420 to either cause the first circuitry and the first near memory to be powered down or powered up. For example, the first circuitry and the first near memory may be powered down to a lower power state following the sending of flushed context information 435 to the second device. The first circuitry and the first near memory may subsequently be powered up to a higher power state following an indication that the interconnect between the first and second devices is about to be terminated. The indication may be included in connection information 415 (e.g., user input command or wireless range detection).

In some examples, apparatus 400 may also include a context logic 422-8. Context logic 422-8 may be executed by processor circuit 420 to receive context information flushed from the second near memory for the second circuitry that may cause the first circuitry to resume execution of the application. For these examples, the flushed context information may be received in flushed context information and based on at least temporarily storing the received context information flushed from the second near memory to the first near memory, the first circuitry may resume the execution of the application. This may allow for a seamless migration of execution of the application back to the first circuitry at the first device.

Included herein is a set of logic flows representative of example methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow may be implemented in software, firmware, and/or hardware. In software and firmware embodiments, a logic flow may be implemented by computer executable instructions stored on at least one non-transitory computer readable medium or machine readable medium, such as an optical, magnetic or semiconductor storage. The embodiments are not limited in this context.

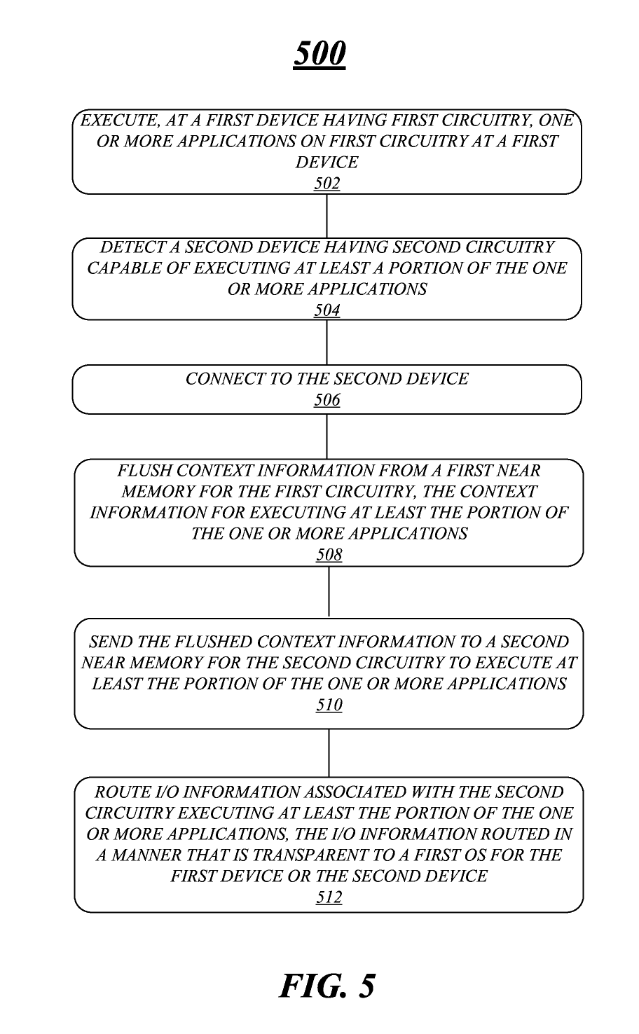

FIG. 5 illustrates an example of a first logic flow. As shown in FIG. 5, the first logic flow includes a logic flow 500. Logic flow 500 may be representative of some or all of the operations executed by one or more logic, features, or devices described herein, such as apparatus 400. More particularly, logic flow 500 may be implemented by detect logic 422-1, connect logic 422-2, flush logic 422-3, send logic 422-4, I/O logic 422-5, coherency logic 422-6, power logic 422-7 or context logic 422-8.

In the illustrated example shown in FIG. 5, logic flow 500 at block 502 may execute, at a first device having first circuitry, one or more applications on first circuitry at a first device.

According to some examples, logic flow 500 at block 504 may detect a second device having second circuitry capable of executing at least a portion of the one or more applications. For these examples, detect logic 422-1 may detect the second device having the second circuitry.

In some examples, logic flow 500 at block 506 may connect to the second device. For these examples, connect logic 422-2 may cause the connection via an interconnect to become established through either a wired or wireless communication channel.

According to some examples, logic flow at block 508 may flush context information from a first near memory for the first circuitry. The context information may be for executing at least the portion of the one or more applications. For these examples, flush logic 422-3 may cause the context information to be flushed.

In some examples, logic flow at block 510 may send the flushed context information to a second near memory for the second circuitry to execute at least the portion of the one or more applications. For these examples, send logic 422-4 may cause the flushed context information to be sent.

According to some examples, logic flow at block 512 may route I/O information associated with the second circuitry executing at least the portion of the one or more applications. The I/O information may be routed in a manner that is transparent to a first OS for the first device or the second device. For these examples, I/O logic 422-5 may cause the I/O information to be routed in the manner that is transparent to the first OS.

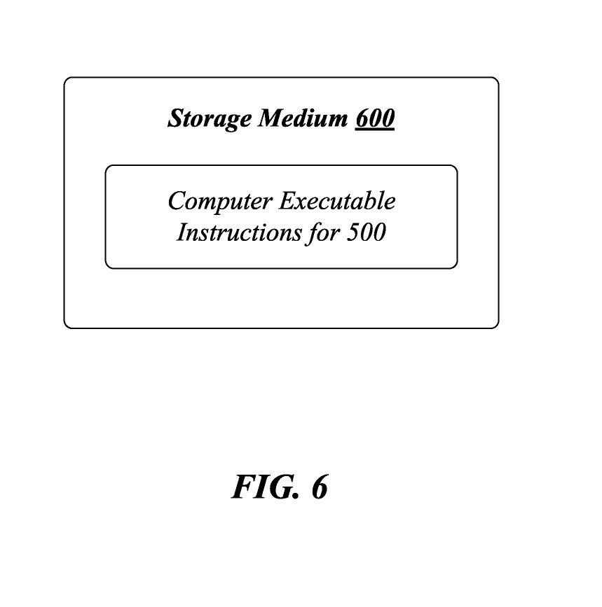

FIG. 6 illustrates an embodiment of a first storage medium. As shown in FIG. 6, the first storage medium includes a storage medium 600. Storage medium 600 may comprise an article of manufacture. In some examples, storage medium 600 may include any non-transitory computer readable medium or machine readable medium, such as an optical, magnetic or semiconductor storage. Storage medium 600 may store various types of computer executable instructions, such as instructions to implement logic flow 500. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

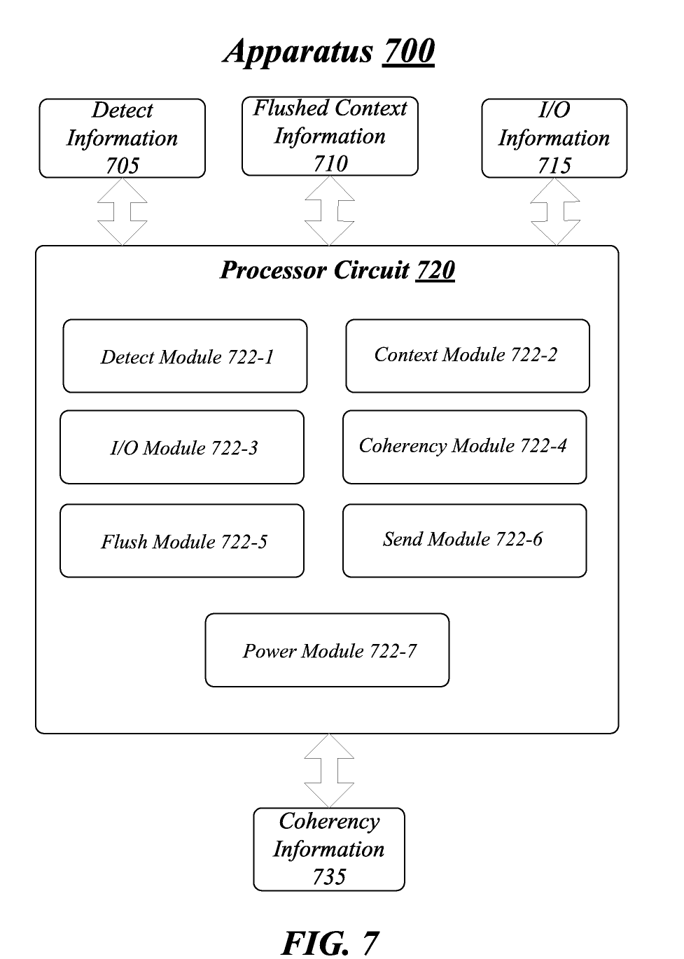

FIG. 7 illustrates a block diagram for a second apparatus. As shown in FIG. 7, the second apparatus includes an apparatus 700. Although apparatus 700 shown in FIG. 7 has a limited number of elements in a certain topology or configuration, it may be appreciated that apparatus 700 may include more or less elements in alternate configurations as desired for a given implementation.

The apparatus 700 may comprise a computer-implemented apparatus 700 having a processor circuit 720 arranged to execute one or more logics 722-a. Similar to apparatus 400 for FIG. 4, “a” and “b” and “c” and similar designators may be variables representing any positive integer.

According to some examples, apparatus 700 may be part a first device having first circuitry for executing an application (e.g. device 155 or 255). The examples are not limited in this context.

In some examples, as shown in FIG. 7, apparatus 700 includes processor circuit 720. Processor circuit 720 may be generally arranged to execute one or more logics 722-a. Processor circuit 720 can be any of various commercially available processors to include, but not limited to, those previously mentioned for processor circuit 420 for apparatus 400. Dual microprocessors, multi-core processors, and other multi-processor architectures may also be employed as processor circuit 720. According to some examples processor circuit 720 may also be an application specific integrated circuit (ASIC) and logics 722-a may be implemented as hardware elements of the ASIC.

According to some examples, apparatus 700 may include a detect logic 722-1. Detect logic 722-1 may be executed by processor circuit 720 to detect an indication that a second device having second circuitry has connected to the first device via an interconnect. For example, detect logic 722-1 may receive detect information 705 that may indicate that the second device has connected to the first device via either a wired or wireless communication channel.

In some examples, apparatus 700 may also include a context logic 722-2. Context logic 722-2 may be executed by processor circuit 720 to receive, via the interconnect, context information flushed from a first near memory for the second circuitry. The flushed context information may enable the first circuitry at the first device to execute at least a portion of one or more applications previously executed by the second circuitry prior to flushing the context information. The received context information may be at least temporarily stored to a second near memory for the first circuitry at the first device. For these examples, context logic 722-2 may receive the flushed context information in flushed context information 710.

In some examples, apparatus 700 may also include an I/O logic 722-3. I/O logic 722-3 may be executed by processor circuit 720 to receive, via the interconnect, I/O information associated with the first circuitry executing at least the portion of the one or more applications. The I/O information may be received in a manner that is transparent to a first OS for the first device or the second device. For example, the I/O information may be included in I/O information 715 and may include such information as detected user input commands at the second device for affecting the execution of the at least portion of the one or more applications.

According to some examples, apparatus 700 may also include a coherency logic 722-4. Coherency logic 722-4 may be executed by processor circuit 720 to maintain coherency information between the first circuitry and the second circuitry via the interconnect to enable execution of the one or more applications in a distributed or shared manner. For these examples, the second circuitry may execute at least the portion of the one or more applications while the first circuitry executes a remaining portion of the one or more applications. For example, coherency information included in coherency information 735 may be exchanged between the first and second device to allow coherency logic 722-4 to maintain the coherency information.

In some examples, apparatus 700 may also include a flush logic 722-5. Flush logic 722-5 may be executed by processor circuit 720 to flush context information for executing at least the portion of the one or more applications from the second near memory for the first device. This flushed context information may be responsive to a detection by detect logic 722-1 of an indication that the connection to the second device via the interconnect is about to be terminated.

According to some examples, apparatus 700 may include a send logic 722-6. Send logic 722-6 may be executed by processor circuit 720 to send, via the interconnect, the flushed context information from the second near memory to the first near memory at the second device. The sent flushed context information may be for the second circuitry to resume execution of at least the portion of the one or more application. For example, the flushed context information may be included in flushed context information 710.

In some examples, apparatus 700 may include a power logic 722-7. Power logic 722-7 may be executed by processor circuit 720 to either power down or power up the first circuitry and the second near memory at the first device. For example, the first circuitry and the second near memory may be powered down to a lower power state following the sending of flushed context information 710 to the second device.

Various components of apparatus 700 and a device implementing apparatus 700 may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Example connections include parallel interfaces, serial interfaces, and bus interfaces.

Included herein is a set of logic flows representative of example methodologies for performing novel aspects of the disclosed architecture. While, for purposes of simplicity of explanation, the one or more methodologies shown herein are shown and described as a series of acts, those skilled in the art will understand and appreciate that the methodologies are not limited by the order of acts. Some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

A logic flow may be implemented in software, firmware, and/or hardware. In software and firmware embodiments, a logic flow may be implemented by computer executable instructions stored on at least one non-transitory computer readable medium or machine readable medium, such as an optical, magnetic or semiconductor storage. The embodiments are not limited in this context.

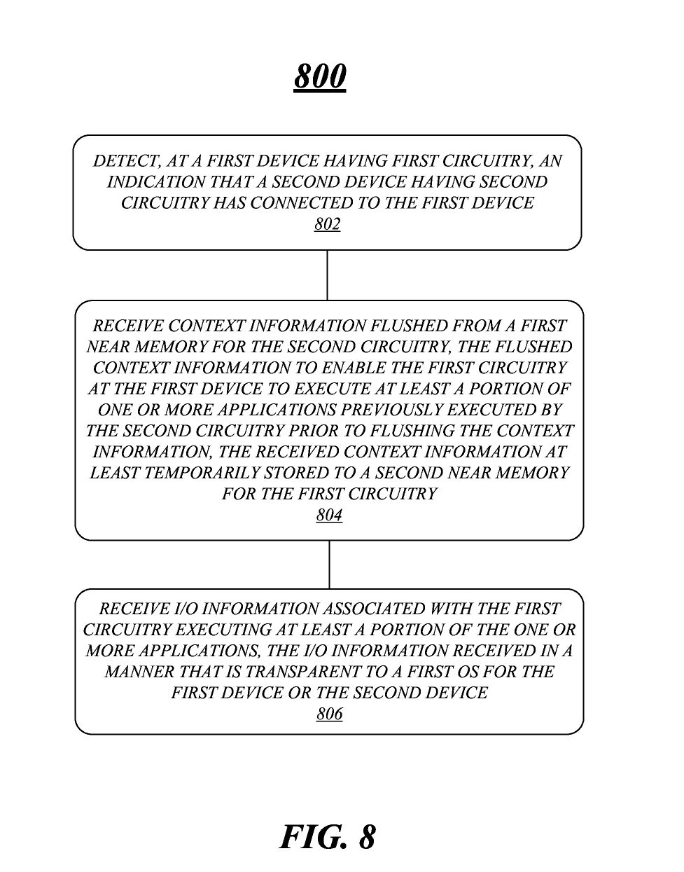

FIG. 8 illustrates an example of a second logic flow. As shown in FIG. 8, the second logic flow includes a logic flow 800. Logic flow 800 may be representative of some or all of the operations executed by one or more logic, features, or devices described herein, such as apparatus 800. More particularly, logic flow 800 may be implemented by detect logic 722-1, context logic 722-2, I/O logic 722-3, coherency logic 722-4, flush logic 722-5, send logic 722-6 or power logic 722-7.

In the illustrated example shown in FIG. 8, logic flow 800 at block 802 may detect, at a first device having first circuitry, an indication that a second device having second circuitry has connected to the first device. For example, detect logic 722-1 may detect the second device.

In some examples, logic flow 800 at block 804 may receive context information flushed from a first near memory for the second circuitry. The flushed context information may enable the first circuitry at the first device to execute at least a portion of one or more applications previously executed by the second circuitry prior to flushing the context information. The received context information at least temporarily stored to a second near memory for the first circuitry. For these examples, context logic 722-2 may receive the flushed context information.

According to some examples, logic flow 800 at block 806 may receive I/O information associated with the first circuitry executing at least a portion of the one or more applications. The I/O information received in a manner that may be transparent to a first OS for the first device or the second device. For these examples, I/O logic 722-3 may receive the I/O information.

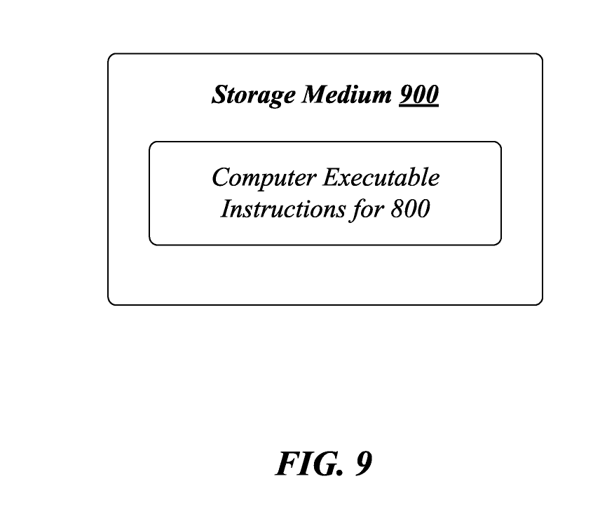

FIG. 9 illustrates an embodiment of a second storage medium. As shown in FIG. 9, the second storage medium includes a storage medium 900. Storage medium 900 may comprise an article of manufacture. In some examples, storage medium 900 may include any non-transitory computer readable medium or machine readable medium, such as an optical, magnetic or semiconductor storage. Storage medium 900 may store various types of computer executable instructions, such as instructions to implement logic flow 800. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, and the like. The examples are not limited in this context.

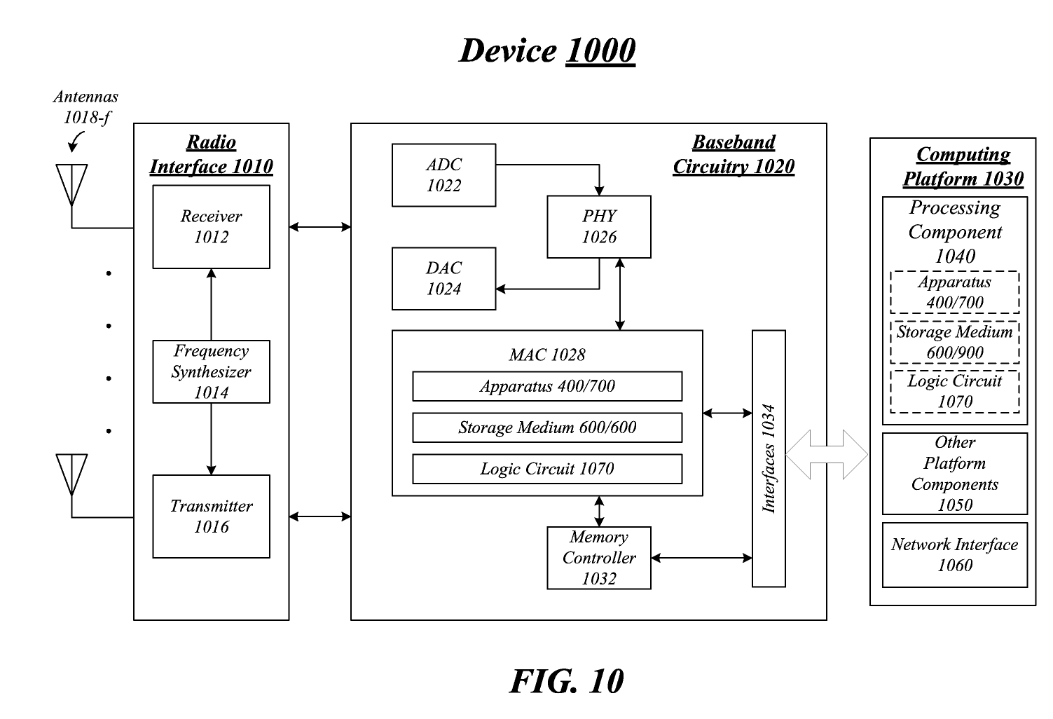

FIG. 10 illustrates an embodiment of a device 1000. In some examples, device 1000 may be configured or arranged for aggregating compute, memory and input/output (I/O) resources with another device. Device 1000 may implement, for example, apparatus 400/700, storage medium 600/900 and/or a logic circuit 1070. The logic circuit 1070 may include physical circuits to perform operations described for apparatus 400/700. As shown in FIG. 10, device 1000 may include a radio interface 1010, baseband circuitry 1020, and computing platform 1030, although examples are not limited to this configuration.

The device 1000 may implement some or all of the structure and/or operations for apparatus 400/700, storage medium 600/900 and/or logic circuit 1070 in a single computing entity, such as entirely within a single device. The embodiments are not limited in this context.

Radio interface 1010 may include a component or combination of components adapted for transmitting and/or receiving single carrier or multi-carrier modulated signals (e.g., including complementary code keying (CCK) and/or orthogonal frequency division multiplexing (OFDM) symbols and/or single carrier frequency division multiplexing (SC-FDM symbols) although the embodiments are not limited to any specific over-the-air interface or modulation scheme. Radio interface 1010 may include, for example, a receiver 1012, a transmitter 1016 and/or a frequency synthesizer 1014. Radio interface 1010 may include bias controls, a crystal oscillator and/or one or more antennas 1018-f. In another embodiment, radio interface 1010 may use external voltage-controlled oscillators (VCOs), surface acoustic wave filters, intermediate frequency (IF) filters and/or RF filters, as desired. Due to the variety of potential RF interface designs an expansive description thereof is omitted.

Baseband circuitry 1020 may communicate with radio interface 1010 to process receive and/or transmit signals and may include, for example, an analog-to-digital converter 1022 for down converting received signals, a digital-to-analog converter 1024 for up converting signals for transmission. Further, baseband circuitry 1020 may include a baseband or physical layer (PHY) processing circuit 1026 for PHY link layer processing of respective receive/transmit signals. Baseband circuitry 1020 may include, for example, a processing circuit 1028 for medium access control (MAC)/data link layer processing. Baseband circuitry 1020 may include a memory controller 1032 for communicating with MAC processing circuit 1028 and/or a computing platform 1030, for example, via one or more interfaces 1034.

In some embodiments, PHY processing circuit 1026 may include a frame construction and/or detection logic, in combination with additional circuitry such as a buffer memory, to construct and/or deconstruct communication frames (e.g., containing subframes). Alternatively or in addition, MAC processing circuit 1028 may share processing for certain of these functions or perform these processes independent of PHY processing circuit 1026. In some embodiments, MAC and PHY processing may be integrated into a single circuit.

Computing platform 1030 may provide computing functionality for device 1000. As shown, computing platform 1030 may include a processing component 1040. In addition to, or alternatively of, baseband circuitry 1020 of device 1000 may execute processing operations or logic for apparatus 400/700, storage medium 600/900, and logic circuit 1070 using the processing component 1030. Processing component 1040 (and/or PHY 1026 and/or MAC 1028) may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an example is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given example.

Computing platform 1030 may further include other platform components 1050. Other platform components 1050 include common computing elements, such as one or more processors, multi-core processors, co-processors, memory units, chipsets, controllers, peripherals, interfaces, oscillators, timing devices, video cards, audio cards, multimedia input/output (I/O) components (e.g., digital displays), power supplies, and so forth. Examples of memory units may include without limitation various types of computer readable and machine readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information.

Computing platform 1030 may further include a network interface 1060. In some examples, network interface 1060 may include logic and/or features to support network interfaces operated in compliance with one or more wireless or wired technologies such as those described above for connecting to another device via a wired or wireless communication channel to establish an interconnect between the devices.

Device 1000 may be, for example, user equipment, a computer, a personal computer (PC), a desktop computer, a laptop computer, a notebook computer, a netbook computer, a tablet computer, an ultra-book computer, a smart phone, a wearable computing device, embedded electronics, a gaming console, a server, a server array or server farm, a web server, a network server, an Internet server, a work station, a mini-computer, a main frame computer, a supercomputer, a network appliance, a web appliance, a distributed computing system, multiprocessor systems, processor-based systems, or combination thereof. Accordingly, functions and/or specific configurations of device 1000 described herein, may be included or omitted in various embodiments of device 1000, as suitably desired.

Embodiments of device 1000 may be implemented using single input single output (SISO) architectures. However, certain implementations may include multiple antennas (e.g., antennas 1018-f) for transmission and/or reception using adaptive antenna techniques for beamforming or spatial division multiple access (SDMA) and/or using multiple input multiple output (MIMO) communication techniques.

The components and features of device 1000 may be implemented using any combination of discrete circuitry, application specific integrated circuits (ASICs), logic gates and/or single chip architectures. Further, the features of device 1000 may be implemented using microcontrollers, programmable logic arrays and/or microprocessors or any combination of the foregoing where suitably appropriate. It is noted that hardware, firmware and/or software elements may be collectively or individually referred to herein as “logic” or “circuit.”

It should be appreciated that the exemplary device 1000 shown in the block diagram of FIG. 10 may represent one functionally descriptive example of many potential implementations. Accordingly, division, omission or inclusion of block functions depicted in the accompanying figures does not infer that the hardware components, circuits, software and/or elements for implementing these functions would be necessarily be divided, omitted, or included in embodiments.

Some examples may be described using the expression “in one example” or “an example” along with their derivatives. These terms mean that a particular feature, structure, or characteristic described in connection with the example is included in at least one example. The appearances of the phrase “in one example” in various places in the specification are not necessarily all referring to the same example.

Some examples may be described using the expression “coupled”, “connected”, or “capable of being coupled” along with their derivatives. These terms are not necessarily intended as synonyms for each other. For example, descriptions using the terms “connected” and/or “coupled” may indicate that two or more elements are in direct physical or electrical contact with each other. The term “coupled,” however, may also mean that two or more elements are not in direct contact with each other, but yet still co-operate or interact with each other.

It is emphasized that the Abstract of the Disclosure is provided to comply with 37 C.F.R. Section 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single example for the purpose of streamlining the disclosure. This method of disclosure is not to be interpreted as reflecting an intention that the claimed examples require more features than are expressly recited in each claim. Rather, as the following claims reflect, inventive subject matter lies in less than all features of a single disclosed example. Thus the following claims are hereby incorporated into the Detailed Description, with each claim standing on its own as a separate example. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

In some examples, an example first apparatus may include a processor circuit for a first device having first circuitry to execute an application. The example first apparatus may also include a detect logic to detect a second device having second circuitry capable of executing at least a portion of the application. The example first apparatus may also include a connect logic to cause the first device to connect to the second device. The example first apparatus may also include a flush logic to flush context information from a first near memory for the first circuitry, the context information for executing at least the portion of the application. The example first apparatus may also include a send logic to send the flushed context information to a second near memory for the second circuitry to execute at least the portion of the application. The example first apparatus may also include an I/O logic to route I/O information associated with the second circuitry executing at least the portion of the application, the I/O information routed in a manner that is transparent to a first operating system for the first device or the second device.

According to some examples for the example first apparatus, the flush logic may flush the context information to a far memory at the first device prior to the send logic sending the flushed context information to the second near memory. The first near memory, the second near memory and the far memory may be included in a 2LM scheme implemented at least at the first device.

According to some examples, the example first apparatus may also include a power logic to cause the first circuitry and the first near memory to power down to a lower power state following the sending of the flushed context information to the second near memory. The power logic may also cause power to be continued for I/O components of the first device. The I/O components may include one or more of the far memory, a storage device, a network interface or a user interface.

In some examples for the example first apparatus, the connect logic may receive an indication the connection to the second device is to be terminated. For these examples, the power logic may then cause the first circuitry and the first near memory to power up the first circuitry and the first near memory to a higher power state. The example first apparatus may also include a context logic to receive context information flushed from the second near memory for the second circuitry and cause the first circuitry to resume execution of the application.

According to some examples, the example first apparatus may also include a coherency logic to maintain coherency information between the first circuitry and the second circuitry to enable execution of the application in a distributed or shared manner. The second circuitry may execute at least the portion of the application while the first circuitry executes a remaining portion of the application.

In some examples for the example first apparatus, the detect logic may detect the second device responsive to the first device coupling to a wired interface that enables the connect logic to establish a wired communication channel to connect with the second device via an interconnect.

According some examples for the example first apparatus, the detect logic may detect the second device responsive to the first device coming within a given physical proximity that enables the connect logic to establish a wireless communication channel to connect with the second device via an interconnect.

In some examples for the example first apparatus, the I/O logic may route I/O information indicating an input command for the application. The input command may be received via a keyboard input event at the first device or via a natural UI input event detected by the first device. The natural UI input event may include a touch gesture, an air gesture, a first device gesture that includes purposeful movement of at least a portion of the first device, an audio command, an image recognition or a pattern recognition.

According some examples for the example first apparatus, the first device may include one or more of the first device having a lower thermal capacity for dissipating heat from the first circuitry compared to a higher thermal capacity for dissipating heat from the second circuitry at the second device, the first device operating on battery power or the first device having a lower current-carrying capacity for powering the first circuitry compared to a higher current-carrying capacity for powering the second circuitry at the second device.

In some examples, example first methods may include executing on first circuitry at a first device one or more applications. The example first methods may also include detecting a second device having second circuitry capable of executing at least a portion of the one or more applications. The example first methods may also include connecting to the second device. The example first methods may also include flushing context information from a first near memory for the first circuitry. The context information may be for executing at least the portion of the one or more applications. The example first methods may also include sending the flushed context information to a second near memory for the second circuitry to execute at least the portion of the one or more applications. The example first methods may also include routing input/output (I/O) information associated with the second circuitry executing at least the portion of the one or more applications. The I/O information may be routed in a manner that is transparent to a first operating system for the first device or the second device.

According to some examples, the first example methods may also include flushing the context information to a far memory at the first device prior to sending the flushed context information to the second near memory. The first near memory, the second near memory and the far memory included in a 2LM scheme implemented at least at the first device.

In some examples, the first example methods may also include powering down the first circuitry and the first near memory to a lower power state following the sending of the flushed context information to the second near memory. Power to I/O components of the first device may be continued. These I/O components may include one or more of the far memory, a storage device, a network interface or a user interface.

In some examples, the first example methods may also include receiving an indication that the connection to the second device is to be terminated. Based on the indication the first circuitry and the first far memory may be powered up to a higher power state. The first example methods may also include receiving context information flushed from the second near memory for the second circuitry and the resuming execution of the one or more applications on the first circuitry by at least temporarily storing the received context information flushed from the second near memory in the far memory prior to sending the flushed context information to the first near memory.

According to some examples, the first example methods may also include maintaining coherency information between the first circuitry and the second circuitry to enable execution of the one or more applications in a distributed or shared manner. The second circuitry may execute at least the portion of the one or more applications while the first circuitry executes a remaining portion of the one or more applications.

In some examples for the first example methods, detecting the second device may be responsive to the first device coupling to a wired interface that enables the first device to establish a wired communication channel to connect with the second device via an interconnect.

According to some examples for the first example methods, detecting the second device may be responsive to the first device coming within a given physical proximity that enables the first device to establish a wireless communication channel to connect with the second device via an interconnect.

In some examples for the first example methods, the one or more applications may include one of at least a 4K resolution streaming video application, an application to present at least a 4K resolution image or graphic to a display, a gaming application including video or graphics having at least a 4K resolution when presented to a display, a video editing application or a touch screen application for user input to a display coupled to the second device having touch input capabilities.

According to some examples for the first example methods, routing I/O information associated with the second circuitry executing at least the portion of the one or more applications may include routing 4K resolution streaming video information obtained by the first device via a network connection. The at least 4K resolution streaming video application may cause the 4K streaming video to be presented on a display coupled to the second device having a vertical display distance of at least 15 inches.

In some examples for the first example methods, routing I/O information associated with the second circuitry executing at least the portion of the one or more applications may include routing I/O information indicating an input command for the one or more applications. The input command may be received via a keyboard input event at the first device or via a natural user interface (UI) input event detected by the first device. The natural UI input event may include a touch gesture, an air gesture, a first device gesture that includes purposeful movement of at least a portion of the first device, an audio command, an image recognition or a pattern recognition.

According to some examples for the first example methods, the first device may include one or more of the first device having no active cooling capacity for the first circuitry, the first device having a lower thermal capacity for dissipating heat from the first circuitry compared to a higher thermal capacity for dissipating heat from the second circuitry at the second device, the first device operating on battery power or the first device having a lower current-carrying capacity for powering the first circuitry compared to a higher current-carrying capacity for powering the second circuitry at the second device.

In some examples for the first example methods, active cooling may include using a powered fan for dissipating heat.

According to some examples for the first example methods, the first circuitry may include one or more processing elements and a graphics engine.

In some examples, an example first at least one machine readable medium comprising a plurality of instructions that in response to being executed on a first device having first circuitry causes the first device to execute on first circuitry at the first device one or more applications. The instructions may also cause the first device to detect a second device having second circuitry capable of executing at least a portion of the one or more applications. The instructions may also cause the first device to connect to the second device. The instructions may also cause the first device to flush context information from a first near memory for the first circuitry, the context information for executing the one or more applications. The instructions may also cause the first device to send the flushed context information to a second near memory for the second circuitry to execute the one or more applications. The instructions may also cause the first device to route I/O information associated with the second circuitry executing the one or more applications. The I/O information may be routed in a manner that is transparent to a first operating system for the first device or the second device.

According to some examples for the first at least one machine readable medium, the instructions may also cause the first device to detect the second device responsive to the first device coupling to a wired interface that enables the first device to establish a wired communication channel to connect with the second device via an interconnect.

In some examples for the first at least one machine readable medium, the instructions may also cause the first device to detect the second device responsive to the first device coming within a given physical proximity that enables the first device to establish a wireless communication channel to connect with the second device via an interconnect.

According to some examples for the first at least one machine readable medium, the one or more applications may include one of at least a 4K resolution streaming video application, an application to present at least a 4K resolution image or graphic to a display, a gaming application including video or graphics having at least a 4K resolution when presented to a display, a video editing application or a touch screen application for user input to a display coupled to the second device having touch input capabilities.

In some examples for the first at least one machine readable medium, the instructions may also cause the first device to route I/O information associated with the second circuitry executing the one or more applications comprises routing 4K resolution streaming video information obtained by the first device via a network connection. For these examples, the at least 4K resolution streaming video application may cause the 4K streaming video to be presented on a display coupled to the second device having a vertical display distance of at least 15 inches.

According to some examples for the first at least one machine readable medium, the first device may include one or more of the first device having a lower thermal capacity for dissipating heat from the first circuitry compared to a higher thermal capacity for dissipating heat from the second circuitry at the second device. The first device may be operating on battery power or the first device having a lower current-carrying capacity for powering the first circuitry compared to a higher current-carrying capacity for powering the second circuitry at the second device.

In some examples for the first at least one machine readable medium, the first circuitry may include one or more processing elements and a graphics engine.

In some examples, an example second apparatus may include a processor circuit for a first device having first circuitry. The example second apparatus may also include a detect logic to detect an indication that a second device having second circuitry has connected to the first device. The example second apparatus may also include a context logic to receive, context information flushed from a first near memory for the second circuitry. The flushed context information may enable the first circuitry at the first device to execute at least a portion of one or more applications previously executed by the second circuitry prior to flushing the context information. The received context information may be at least temporarily stored to a second near memory for the first circuitry. The example second apparatus may also include an I/O logic to receive I/O information associated with the first circuitry executing at least the portion of the one or more applications. The I/O information may be received in a manner that is transparent to a first operating system for the first device or the second device.

According to some examples for the example second apparatus, the I/O logic may continue to receive the I/O information routed from the second device in a manner that is transparent to the first operating system. For these examples, the I/O logic may provide the continually received I/O information for the first circuitry to continue to execute at least a portion of the one or more applications.

In some examples for the example second apparatus, the context information may be initially flushed to a far memory at the second device and then routed to the second near memory at the first device, the first near memory. The second near memory and the far memory may be included in a 2LM scheme implemented at both the first and second devices.

According to some examples for the example second apparatus, the detection logic may receive an indication that the connection to the second device via the interconnect is to be terminated. The example second apparatus may also include a flush logic to flush context information for executing at least the portion of the one or more applications from the second near memory for the first device. The example second apparatus may also include a send logic to send the flushed context information from the second near memory to the far memory at the second device and then to the first near memory at the second device, the sent flushed context information for the second circuitry to resume execution of at least the portion of the one or more applications. The example second apparatus may also include a power logic to power down the first circuitry and the second near memory to a lower power state following the context logic sending the flushed context information to the first near memory.

In some examples, the example second apparatus may also include a coherency logic to maintain coherency information between the first circuitry and the second circuitry to enable execution of the one or more applications in a distributed or shared manner. The second circuitry may execute at least the portion of the one or more applications while the first circuitry executes a remaining portion of the one or more applications.

According to some examples for the example second apparatus, the detect logic may detect the indication that the second device has connected responsive to the second device coupling to a wired interface that enables the first device to establish a wired communication channel to connect with the second device via an interconnect.

In some examples for the example second apparatus, the detect logic may detect the indication that the second device has connected responsive to the second device coming within a given physical proximity that enables the first device to establish a wireless communication channel to connect with the second device via an interconnect.

According to some examples for the example second apparatus, the first circuitry executing at least the portion of the one or more applications may include one of causing at least a 4K resolution streaming video to be presented on a display coupled to the first device, causing at least a 4K resolution image or graphic to be presented on a display coupled to the first device or causing a touch screen to be presented on a display coupled to the first device, the display having touch input capabilities.

In some examples for the example second apparatus, the first device may include one or more of the first device having a higher thermal capacity for dissipating heat from the first circuitry compared to a lower thermal capacity for dissipating heat from the second circuitry at the second device. The first device may be operating on a fixed power source from a power outlet or the first device having a higher current-carrying capacity for powering the first circuitry compared to a lower current-carrying capacity for powering the second circuitry at the second device.

In some examples, example second methods may include detecting, at a first device having first circuitry, an indication that a second device having second circuitry has connected to the first device. Context information may be received that was flushed from a first near memory for the second circuitry. The flushed context information may enable the first circuitry at the first device to execute at least a portion of one or more applications previously executed by the second circuitry prior to flushing the context information. The received context information may be at least temporarily stored to a second near memory for the first circuitry. I/O information may then be received the I/O information may be associated with the first circuitry executing at least a portion of the one or more applications. The I/O information may be received in a manner that is transparent to a first operating system for the first device or the second device.

According to some examples for the second example methods, at least the portion of the one or more applications may continue to be executed based on the I/O information being routed from the second device in the manner that is transparent to the first operating system.

In to some examples for the second example methods, the context information may be initially flushed to a far memory at the second device and then routed to the second near memory at the first device. The first near memory, the second near memory and the far memory included in a 2LM scheme implemented at both the first and second devices.

According to some examples, the example second methods may also include receiving an indication that the connection to the second device is to be terminated and then flushing context information for executing at least the portion of the one or more applications from the second near memory for the first device. The flushed context information may then be sent from the second near memory to the far memory at the second device and then to the first near memory at the second device. The sent flushed context information may be for the second circuitry to resume execution of at least the portion of the one or more applications. The first circuitry and the second near memory may then be powered down to a lower power state following the sending of the flushed context information to the first near memory.

In to some examples, the second example methods may also include maintaining coherency information between the first circuitry and the second circuitry to enable execution of the one or more applications in a distributed or shared manner. The second circuitry may execute at least the portion of the one or more applications while the first circuitry executes a remaining portion of the one or more applications.

According to some examples for the second example methods, detecting the indication that the second device has connected may be responsive to the second device coupling to a wired interface that enables the first device to establish a wired communication channel to connect with the second device via an interconnect.

In to some examples for the second example methods, detecting the indication that the second device has connected may be responsive to the second device coming within a given physical proximity that enables the first device to establish a wireless communication channel to connect with the second device via an interconnect.

According to some examples for the second example methods, executing at least the portion of the one or more applications may include one of causing at least a 4K resolution streaming video to be presented on a display coupled to the first device, causing at least a 4K resolution image or graphic to be presented on a display coupled to the first device or causing a touch screen to be presented on a display coupled to the first device, the display having touch input capabilities.

In to some examples for the second example methods, the first device may include one or more of the first device having a higher thermal capacity for dissipating heat from the first circuitry compared to a lower thermal capacity for dissipating heat from the second circuitry at the second device. The first device may be operating on a fixed power source from a power outlet or the first device having a higher current-carrying capacity for powering the first circuitry compared to a lower current-carrying capacity for powering the second circuitry at the second device.

In some examples, an example second at least one machine readable medium comprising a plurality of instructions that in response to being executed on a first device having first circuitry causes the first device to detect an indication that a second device having second circuitry has connected to the first device. The instructions may also cause the first device to receive context information flushed from a first near memory for the second circuitry. The flushed context information may enable the first circuitry at the first device to execute one or more applications previously executed by the second circuitry prior to flushing the context information. The received context information may be at least temporarily stored to a second near memory for the first circuitry. The instructions may also cause the first device to receive I/O information associated with the first circuitry executing the one or more applications. The I/O information may be received in a manner that is transparent to a first operating system for the first device or the second device.

According to some examples for the second at least one machine readable medium, the second circuitry may continue to execute the one or more applications based on the I/O information being routed from the second device via the interconnect in the manner that is transparent to the first operating system.

In some examples for the second at least one machine readable medium, the context information initially flushed to a far memory at the second device and then routed to the second near memory at the first device. The first near memory, the second near memory and the far memory may be included in a 2LM scheme implemented at both the first and second devices.

According to some examples for the second at least one machine readable medium, the instructions may also cause the first device to receive an indication that the connection to the second device is to be terminated, flush context information for executing the one or more applications from the second near memory for the first device and send the flushed context information from the second near memory to the far memory at the second device and then to the first near memory at the second device. The sent flushed context information for the second circuitry to resume execution of the one or more applications. The instructions may also cause the first device to power down the first circuitry and the second near memory to a lower power state following the sending of the flushed context information to the first near memory.

In some examples for the second at least one machine readable medium, the instructions to also cause the first device to detect the indication that the second device has connected responsive to the second device coupling to a wired interface that enables the first device to establish a wired communication channel to connect with the second device via an interconnect.

According to some examples for the second at least one machine readable medium, the instructions to also cause the first device to detect the indication that the second device has connected responsive to the second device coming within a given physical proximity that enables the first device to establish a wireless communication channel to connect with the second device via an interconnect.

In some examples for the second at least one machine readable medium, the first circuitry executing the one or more applications may include one of causing at least a 4K resolution streaming video to be presented on a display coupled to the first device, causing at least a 4K resolution image or graphic to be presented on a display coupled to the first device or causing a touch screen to be presented on a display coupled to the first device, the display having touch input capabilities.

According to some examples for the second at least one machine readable medium, the first device may include one or more of the first device having a higher thermal capacity for dissipating heat from the first circuitry compared to a lower thermal capacity for dissipating heat from the second circuitry at the second device. The first device may be operating on a fixed power source from a power outlet or the first device having a higher current-carrying capacity for powering the first circuitry compared to a lower current-carrying capacity for powering the second circuitry at the second device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. An apparatus comprising:
a processor circuit for a first device having first circuitry to execute an application;
a detect logic to detect a second device having second circuitry capable of executing at least a portion of the application;
a connect logic to cause the first device to connect to the second device;
a flush logic to flush context information from a first near memory for the first circuitry, the context information for executing at least the portion of the application;
a send logic to send the flushed context information to a second near memory for the second circuitry to execute at least the portion of the application; and
an input/output (I/O) logic to route I/O information associated with the second circuitry executing at least the portion of the application, the I/O information routed in a manner that is transparent to a first operating system for the first device or the second device.

2. The apparatus of claim 1, comprising the flush logic to flush the context information to a far memory at the first device prior to the send logic sending the flushed context information to the second near memory, the first near memory, the second near memory and the far memory included in a two-level memory (2LM) scheme implemented at least at the first device.

3. The apparatus of claim 1, comprising:
a power logic to power down the first circuitry and the first near memory to a lower power state following the sending of the flushed context information to the second near memory and cause continued power to I/O components of the first device, the I/O components to include one or more of the far memory, a storage device, a network interface or a user interface.

4. The apparatus of claim 3, comprising:
the connect logic to receive an indication the connection to the second device is to be terminated;
the power logic to cause the first circuitry and the first near memory to power up the first circuitry and the first near memory to a higher power state; and
a context logic to receive context information flushed from the second near memory for the second circuitry and cause the first circuitry to resume execution of the application.

5. The apparatus of claim 1, comprising:
a coherency logic to maintain coherency information between the first circuitry and the second circuitry to enable execution of the application in a distributed or shared manner, the second circuitry to execute at least the portion of the application while the first circuitry executes a remaining portion of the application.

6. The apparatus of claim 1, comprising the detect logic to detect the second device responsive to the first device coupling to a wired interface that enables the connect logic to establish a wired communication channel to connect with the second device via an interconnect.

7. The apparatus of claim 1, comprising the detect logic to detect the second device responsive to the first device coming within a given physical proximity that enables the connect logic to establish a wireless communication channel to connect with the second device via an interconnect.

8. The apparatus of claim 1, comprising the I/O logic to route I/O information indicating an input command for the application, the input command received via a keyboard input event at the first device or via a natural user interface (UI) input event detected by the first device, the natural UI input event to include a touch gesture, an air gesture, a first device gesture that includes purposeful movement of at least a portion of the first device, an audio command, an image recognition or a pattern recognition.

9. The apparatus of claim 1, the first device comprising one or more of the first device having a lower thermal capacity for dissipating heat from the first circuitry compared to a higher thermal capacity for dissipating heat from the second circuitry at the second device, the first device operating on battery power or the first device having a lower current-carrying capacity for powering the first circuitry compared to a higher current-carrying capacity for powering the second circuitry at the second device.

10. A method comprising:
executing on first circuitry at a first device one or more applications;
detecting a second device having second circuitry capable of executing at least a portion of the one or more applications;
connecting to the second device;
flushing context information from a first near memory for the first circuitry, the context information for executing at least the portion of the one or more applications;
sending the flushed context information to a second near memory for the second circuitry to execute at least the portion of the one or more applications; and
routing input/output (I/O) information associated with the second circuitry executing at least the portion of the one or more applications, the I/O information routed in a manner that is transparent to a first operating system for the first device or the second device.

11. The method of claim 10, comprising:
flushing the context information to a far memory at the first device prior to sending the flushed context information to the second near memory, the first near memory, the second near memory and the far memory included in a two-level memory (2LM) scheme implemented at least at the first device.

12. The method of claim 11, comprising:
powering down the first circuitry and the first near memory to a lower power state following the sending of the flushed context information to the second near memory; and
continuing to power I/O components of the first device, the I/O components to include one or more of the far memory, a storage device, a network interface or a user interface.

13. The method of claim 12, comprising:
receiving an indication that the connection to the second device is to be terminated;
powering up the first circuitry and the first far memory to a higher power state;
receiving context information flushed from the second near memory for the second circuitry; and
resuming execution of the one or more applications on the first circuitry by at least temporarily storing the received context information flushed from the second near memory in the far memory prior to sending the flushed context information to the first near memory.

14. The method of claim 10, comprising:
maintaining coherency information between the first circuitry and the second circuitry to enable execution of the one or more applications in a distributed or shared manner, the second circuitry to execute at least the portion of the one or more applications while the first circuitry executes a remaining portion of the one or more applications.

15. The method of claim 10, comprising detecting the second device responsive to the first device coupling to a wired interface that enables the first device to establish a wired communication channel to connect with the second device via an interconnect.

16. The method of claim 10, comprising detecting the second device responsive to the first device coming within a given physical proximity that enables the first device to establish a wireless communication channel to connect with the second device via an interconnect.

17. The method of claim 10, the one or more applications comprises one of at least a 4K resolution streaming video application, an application to present at least a 4K resolution image or graphic to a display, a gaming application including video or graphics having at least a 4K resolution when presented to a display, a video editing application or a touch screen application for user input to a display coupled to the second device having touch input capabilities.

18. The method of claim 17, routing I/O information associated with the second circuitry executing at least the portion of the one or more applications comprises routing 4K resolution streaming video information obtained by the first device via a network connection, the at least 4K resolution streaming video application to cause the 4K streaming video to be presented on a display coupled to the second device having a vertical display distance of at least 15 inches.

19. The method of claim 10, the first device comprising one or more of the first device having no active cooling capacity for the first circuitry, the first device having a lower thermal capacity for dissipating heat from the first circuitry compared to a higher thermal capacity for dissipating heat from the second circuitry at the second device, the first device operating on battery power or the first device having a lower current-carrying capacity for powering the first circuitry compared to a higher current-carrying capacity for powering the second circuitry at the second device.

20. The method of claim 19, active cooling comprises using a powered fan for dissipating heat.

21. The method of claim 10, comprising the first circuitry to include one or more processing elements and a graphics engine.

22. An apparatus comprising:
a processor for a first device having first circuitry;
a detect logic to detect an indication that a second device having second circuitry has connected to the first device;
a context logic to receive context information flushed from a first near memory for the second circuitry, the flushed context information to enable the first circuitry at the first device to execute at least a portion of one or more applications previously executed by the second circuitry prior to flushing the context information, the received context information at least temporarily stored to a second near memory for the first circuitry; and
an input/output (I/O) logic to receive I/O information associated with the first circuitry executing at least the portion of the one or more applications, the I/O information received in a manner that is transparent to a first operating system for the first device or the second device.

23. The apparatus of claim 22, comprising:
the I/O logic to continue to receive the I/O information routed from the second device in a manner that is transparent to the first operating system; and
the I/O logic to provide the continually received I/O information for the first circuitry to continue to execute at least a portion of the one or more applications.

24. The apparatus of claim 22, comprising the context information initially flushed to a far memory at the second device and then routed to the second near memory at the first device, the first near memory, the second near memory and the far memory included in a two-level memory (2LM) scheme implemented at both the first and second devices.

25. The apparatus of claim 22, comprising:
the detection logic to receive an indication that the connection to the second device is to be terminated;
a flush logic to flush context information for executing at least the portion of the one or more applications from the second near memory for the first device;
a send logic to send the flushed context information from the second near memory to the far memory at the second device and then to the first near memory at the second device, the sent flushed context information for the second circuitry to resume execution of at least the portion of the one or more applications; and
a power logic to power down the first circuitry and the second near memory to a lower power state following the context logic sending the flushed context information to the first near memory.

26. The apparatus of claim 22, comprising:
a coherency logic to maintain coherency information between the first circuitry and the second circuitry to enable execution of the one or more applications in a distributed or shared manner, the second circuitry to execute at least the portion of the one or more applications while the first circuitry executes a remaining portion of the one or more applications.

27. At least one machine readable medium comprising a plurality of instructions that in response to being executed on a first device having first circuitry causes the first device to:
detect an indication that a second device having second circuitry has connected to the first device;
receive context information flushed from a first near memory for the second circuitry, the flushed context information to enable the first circuitry at the first device to execute one or more applications previously executed by the second circuitry prior to flushing the context information, the received context information at least temporarily stored to a second near memory for the first circuitry; and
receive input/output (I/O) information associated with the first circuitry executing the one or more applications, the I/O information received in a manner that is transparent to a first operating system for the first device or the second device.

28. The at least one machine readable medium of claim 27, comprising the second circuitry to continue to execute the one or more applications based on the I/O information being routed from the second device in the manner that is transparent to the first operating system.

29. The at least one machine readable medium of claim 27, comprising the context information initially flushed to a far memory at the second device and then routed to the second near memory at the first device, the first near memory, the second near memory and the far memory included in a two-level memory (2LM) scheme implemented at both the first and second devices.

30. The at least one machine readable medium of claim 29, comprising the instructions to also cause the first device to:
receive an indication that the connection to the second device is to be terminated;
flush context information for executing the one or more applications from the second near memory for the first device;
send the flushed context information from the second near memory to the far memory at the second device and then to the first near memory at the second device, the sent flushed context information for the second circuitry to resume execution of the one or more applications; and
power down the first circuitry and the second near memory to a lower power state following the sending of the flushed context information to the first near memory.
